(19) United States
(12) Patent Application Publication
(10) Pub. No.: US 2025/0175251 A1
(43) Pub. Date: May 29, 2025

(54) METHOD AND DEVICE FOR CALIBRATING THE DEMODULATION OF DATA MODULATED BY MODULATING THE AMPLITUDE OF A LIGHT SIGNAL EMITTED BY A LIGHT SOURCE

(71) Applicant: Schneider Electric Industries SAS, Rueil-Malmaison (FR)

(72) Inventors: Lei Jiang, Saint Martin d'Heres (FR); Fabien Hermitte, Meylan (FR); Emmanuel Dreina, Meylan (FR); Jean-Louis Lovato, Biviers (FR)

(73) Assignee: Schneider Electric Industries SAS, Rueil-Malmaison (FR)

(21) Appl. No.: 18/955,180

(22) Filed: Nov. 21, 2024

(30) Foreign Application Priority Data
Nov. 24, 2023 (FR) 2312981

(51) Int. Cl. H04B 10/11; H04B 10/60

(52) U.S. Cl. CPC H04B 10/11; H04B 10/60

(57) ABSTRACT

Method and device for calibrating the demodulation of data modulated by modulating the amplitude of a light signal emitted by a light source The present invention relates to a method and a device for calibrating the demodulation of data modulated by amplitude modulation of a light signal emitted by a light source. The device includes a device (20) for capturing digital images having associated sensitivity and time of exposure parameters, and an electronic computing device (23) implementing modules of:
automatic adjustment (24) of sensitivity and time of exposure parameters,
acquisition (26) of a digital image by said digital image capture device,
extraction (28) of a series of samples from the acquired digital image, each extracted sample taking one of two predetermined values,
calculation (30) of a plurality of sampling factors from said series of samples, each sampling factor being associated with a predetermined pattern and indicative of a number of samples of the same value representative of said pattern, and storage of the calculated sampling factors.

This application claims priority to French Patent Application No. 2312981 filed Nov. 24, 2023, the entire disclosure of which is incorporated by reference herein.

### FIELD OF THE INVENTION

The present invention relates to a method for calibrating the demodulation of data modulated by amplitude modulation of a light signal emitted by a light source.

Same further relates to an associated device for the calibration of the demodulation.

The invention is in the field of wireless communication technology using visible light, using a VLC (Visible Light Communication) system.

### BACKGROUND OF THE INVENTION

The invention applies more particularly within the framework of data communication using an encoder/transmitter implemented on industrial products including on the front a light emitting diode (LED) light indicator e.g. a screen or one or a plurality of light indicators, intended to provide indications on a state of the product, the data being decodable by a VLC receiver/decoder, integrated e.g. into a portable device, e.g. a mobile phone.

For example, the invention applies to products for monitoring and protecting electrical systems, but more generally applies to any type of product including a LED light indicator on the front.

The use of wireless communication technology by means of visible light (VLC), has recently developed and found many applications.

A VLC system includes an encoder/transmitter device and a receiver/decoder device positioned substantially opposite each other. The encoder/emitter device includes a light source, e.g. one or a plurality light-emitting diode (LED) lamps, and the receiver/decoder device includes an image sensor device, e.g. a CMOS camera.

The light source emits a light signal which is amplitude-modulated according to data to be transmitted, the data being coded into symbols by a coding method, each symbol being representative of a bit to be modulated. The symbols are then encapsulated in formatted transmission packets to form a bitstream including a predetermined synchronization word (or synchronization sequence), followed by a formatted transmission packet including a header, useful data and an error detector code. This bitstream is transformed into an electrical signal that controls the activation or deactivation of the light source, at a frequency chosen so that the flicker caused is imperceptible to the human eye. For example, when the light source is switched on (high state of the corresponding light signal), a binary ‘1’ is transmitted, and when the light source is switched off (low state of the corresponding light signal), a binary ‘0’ is transmitted. Another correspondence between high and low states and transmitted bits could be implemented, without changing the principle of the method.

The receiver/decoder device applies digital image processing to the images acquired by the image sensor device in order to perform a demodulation of the modulated data and then a decoding in order to obtain decoded data.

The acquired digital images include matrices of pixels the values of which are representative, in at least one zone illuminated by the light source, of the high or low state of the light source, or of a transition between the states. Thereby, an acquired digital image includes a zone with light and dark fringes, corresponding to the high and low states, respectively, of the light signal. The performance of the demodulation depends more particularly on the operating parameters of the CMOS image sensor device used, in particular on the sensitivity and on the time of exposure. The sensitivity, expressed in ISO or dB (gain), defines the sensitivity of the sensors. The time of exposure defines the “open” time of the sensors, and thus represents the time during which each column of the matrix of a digital image is exposed to light.

In addition, CMOS sensors implement a rolling shutter mechanism that makes it possible to form columns of the acquired digital image, and to form clear vertical fringes when the light source is on (high state of the corresponding light signal), and dark vertical fringes when the light source is off (low state of the corresponding light signal).

The performance of demodulation is further dependent on a sampling factor indicating the ratio of the light or dark fringes of an acquired image to the number of corresponding bits. The sampling factor(s) depend in particular on the acquisition time of a digital image, and on the acquisition time of pixel values, and thus vary depending on the models of the image sensor device.

In the applications envisaged, it is advantageous to use existing electronic devices with at least one integrated CMOS image sensor device, such as mobile phones called smartphones, tablet computers, and laptop computers.

However, there are many models of such electronic devices, incorporating image sensor devices with operation specificities.

It is not practical to consider manual calibration of each model of image sensor device integrated into the various models of portable electronic devices.

### SUMMARY OF THE INVENTION

The object of the invention is to remedy this drawback by proposing an improved demodulation calibration method integrating automatic calibration and automatic calculation of a plurality of sampling factors from the acquired digital images.

To this end, the invention proposes a method of calibration of the demodulation of data modulated by amplitude modulation of a light signal emitted by a light source of an encoder device, the modulated data being encapsulated in formatted transmission packets, the method being implemented by a demodulation calibration device including a digital image capture device having associated sensitivity and time of exposure parameters, and an electronic computing device configured to receive digital images acquired by said image capture device. Such method includes the steps of:
A) automatic adjustment of the sensitivity and time of exposure parameters for placing the image capture device in an image acquisition mode suitable for decoding data transmitted by visible light communication,
B) acquisition of a digital image by that digital image capture device, a digital image acquired comprising a zone comprising a zone with light and dark fringes, corresponding respectively to high and low states of the received light signal,
C) extraction of a series of samples from the acquired digital image, each extracted sample taking one of two predetermined values,
D) calculating a plurality of sampling factors from said series of samples, each sampling factor being associated with a predetermined pattern and indicative of a number of samples of the same value representative of said pattern, and storage, for each predetermined pattern, of the calculated sampling factor associated to said pattern.

Advantageously, the proposed method allows the sensitivity and time of exposure parameters to be tuned and a plurality of sampling factors to be calculated without prior knowledge of the model of image capture device used.

Thereby, advantageously, thereof makes it possible to integrate the proposed demodulation calibration method into any portable electronic device, in particular a smartphone or an electronic tablet, and thus to implement applications using the reading of data transmitted by the VLC system.

The method of calibration of the demodulation of data modulated by amplitude modulation according to the invention may have one or a plurality of the features hereinbelow, taken independently or according to all technically feasible combinations.

The method further includes a step of applying the calculated sampling factors to recover at least one transmitted data packet.

Same includes, after recovery of at least one packet of transmitted data, validation of said data by application of an error detection code.

The method includes the application of steps B) to D) to a predetermined number P of acquired digital images, in order to obtain a plurality of sampling factors per acquired digital image, and a calculation of a mean sampling factor per pattern, equal to the mean value of the sampling factors associated with said pattern for each acquired digital image.

Same further includes an application of the mean sampling factors for the recovery of transmitted data, for a plurality of digital images, of at least one packet of transmitted data per digital image, a validation of the recovered data by application of an error detection code, and a calculation of a validity indicator.

If the validity indicator is less than a validity threshold, steps B) to D) are iterated over said predetermined number of subsequent acquired digital images.

Step D) of calculation of a plurality of sampling factors from said series of samples includes, for each sample value, a count of the numbers of successive samples taking said value, and an arrangement of the counted numbers in descending order in a list associated with said sample value.

The method includes, for each list, filtering to retain only the distinct numbers having an occurrence greater than or equal to two.

The method includes a grouping of the counted numbers distant by at most the predetermined distance threshold, the grouping including a replacement, in the corresponding list, of said counted numbers distant by at most the predetermined distance threshold by an updated number equal to the mean value of said counted numbers distant by at most the predetermined distance threshold.

The method further includes a detection of the presence in one of said lists of an updated number corresponding to a predetermined synchronization word.

In the event of a positive detection, the method includes a calculation of said sampling factors by multiplying each updated number by a predetermined uncertainty coefficient.

The sensitivity is adjusted to 55% of the maximum sensitivity of the image capture device.

According to another aspect, the invention relates to a device of calibration of the demodulation of data modulated by amplitude modulation of a light signal emitted by a light source of an encoder device, the modulated data being encapsulated in formatted transmission packets, including a digital image capture device having associated sensitivity and time of exposure parameters, and an electronic computing device configured to receive digital images acquired by said image capture device, configured to implement a method as briefly described hereinabove.

In one embodiment, the calibration device is a telephone or an electronic tablet.

### BRIEF DESCRIPTION OF THE DRAWINGS

Other features and advantages of the invention will be clear from the description thereof which is given below as a non-limiting example, with reference to the enclosed figures, among which:

FIG. 1 is a schematic representation of a VLC system incorporating a demodulation calibration device according to one embodiment;

FIG. 2 is a flow chart of the main steps of the method of calibration of the demodulation according to one embodiment;

FIG. 3 is a flow chart of the steps for calculating a plurality of sampling factors according to one embodiment;

FIG. 4 is an example of a series of data, lists and sampling factors obtained at the output of the steps shown in FIG. 3.

### DETAILED DESCRIPTION OF EMBODIMENTS

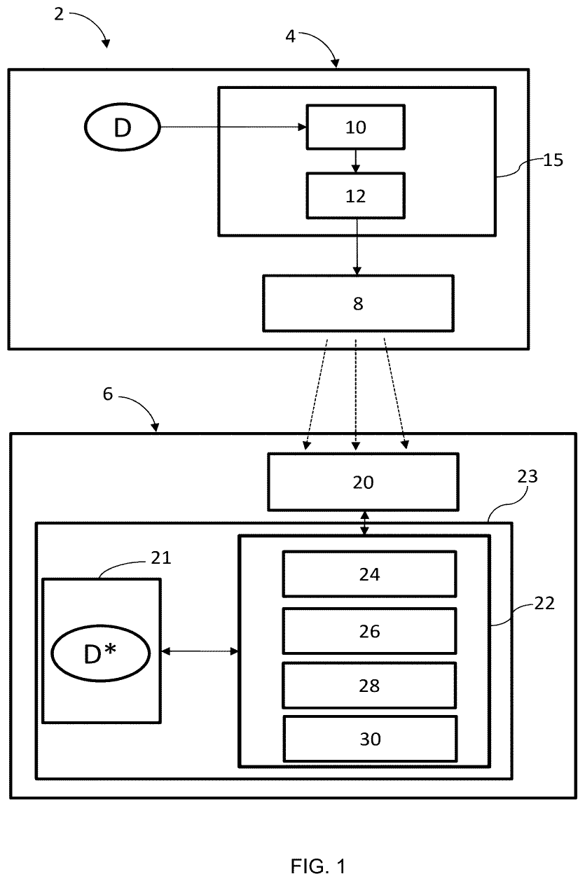

FIG. 1 illustrates a VLC system 2, including an encoder/transmitter device 4 in unidirectional communication with a receiver/decoder device 6.

The transmitter device 4 is configured to encode, modulate and transmit digital data D by using an amplitude modulation of a light signal emitted by a LED light source 8, e.g. formed by one or a plurality lamps, suitable for emitting wavelengths in the visible spectrum, the wavelength being comprised between 380 nm and 780 nm.

The device 4 includes an encoding module 10 and a modulation module 12, which controls the amplitude of a light signal emitted by the light source 8.

The encoding module 10 implements e.g. an encoding which consists in transforming bits into code words, also called symbols. In the VLC system 2, the encoding module 10 implements Manchester coding and formatting in the form of transmission packets formatted according to a chosen protocol.

Manchester coding, according to IEEE standard 802.3, consists in coding a “1” by “01” and a “0” by “10”.

The symbols are then encapsulated in formatted transmission packets to form a bitstream, i.e. a packet including a predetermined synchronization word, followed by a formatted series of symbols including a header, useful data and an error detection code.

For example, when Manchester coding is used, the synchronization word is the pattern ‘1111’ because by definition, said pattern is not part of Manchester code. In other words, no series of Manchester code symbols form a sequence of four ‘1’.

The size of packets is variable, depending on the intended application. The size is indicated in the header of the packages.

The error detection code is e.g. a cyclic redundancy check code such as CRC8 or CRC16.

Themodulation module 12 implements a modulation such as “On-Off Keying” (OOK). In said type of modulation, the light signal emitted by the light source is in the high state (i.e. light source on) to transmit a binary ‘1’ or in the low state (i.e. light source off) to transmit a ‘0’, with a frequency high enough to prevent the flicker from being visible to the human eye.

In one embodiment, the encoding module 10 and the modulation module 12 are implemented by a calculation processor 15.

In a variant, each of the coding 10 and modulation 12 modules is a dedicated module produced in the form of a programmable logic component, such as an FPGA (Field Programmable Gate Array), or else in the form of a dedicated integrated circuit, such as an ASIC (Application Specific Integrated Circuit).

For example, the device 4 is integrated into an industrial product and the light source 8 includes one or a plurality of LED lamps, forming a light indicator initially intended to indicate an operating state of the industrial product.

The light source is preferably integrated so as to illuminate a portion of a face of the industrial product, visible to a user when the industrial product is in the operating position, e.g. when the industrial product is fastened onto a support by one of the faces thereof called the rear face, the illuminated portion being located on the front face of the product.

Advantageously, the modulation of the light signal for transmitting additional digital data does not disturb the initial function of the light indicator of the industrial product.

For example, the digital data D include additional information relating to the industrial product, e.g. a unique identifier of the product, an IP (Internet Protocol) address or a URL (acronym for Uniform Resource Locator or web address), a key or a code, the status of the registers, a BLE (acronym for Bluetooth Low Energy) coupling password or dynamic keys for the commissioning of Zigbee. More generally, the digital data D include information about commissioning or pairing wireless communication, measurements made by the product, and the state of the product. As a result e.g. the installation and the commissioning of a product, or the maintenance of a product by a user, are facilitated. In addition, as a result, the cybersecurity of a product is improved.

The modulated light signal is emitted by the light source 8.

The receiver/decoder device 6 includes an image capture device 20 and an electronic computing device 23.

For example, the image capture device is a CMOS sensor (Complementary metal-oxide-semiconductor) camera suitable for capturing light signals and for converting same into a digital image being composed of one or a plurality matrices of pixels, each pixel of a matrix of pixels having an associated numerical value.

When the device 6 is placed by a user in such a way that the image capture device 20 is placed substantially opposite the light source 8, at a distance from the light source 8 chosen by the user and e.g. comprised between 0 cm (i.e. glued together) and 2 meters, and the receiver device 20 is placed in a VLC reception mode, the or each acquired image comprises, in a zone illuminated by the light signal emitted by the light source, fringes, arranged vertically, representative of the high and low states of the signal emitted or of a transition between the states.

The performance of the demodulation of the modulated data transmitted by the light source depends more particularly on the operating parameters of the image capture device used, i.e. on the sensitivity parameter, defining the sensitivity of the sensors; on the time of exposure, defining the “opening” time of the sensors; and on sampling factors indicating the ratio between the light or dark fringes of an acquired image and the number of corresponding symbols. Advantageously, the calculation of a plurality of sampling factors is proposed, as described in more detail hereinafter.

The digital image acquired by the device 20 is transmitted to the device 23 which performs operations of calibration of the demodulation of modulated data, and, optionally, a demodulation and a decoding for obtaining at the output a set of decoded digital data D*.

In the absence of loss or error, the decoded digital data D* are identical to the digital data D.

The device 23 is an electronic computing device which implements a demodulation calibration method as described hereinafter according to the various embodiments thereof.

The electronic computation device 23 includes a computation unit 22, e.g. one or a plurality of processors and an associated electronic memory unit 21. The electronic memory unit 21 includes in particular memories such as RAM, ROM, any type of non-volatile memory (e.g. EPROM, EEPROM, FLASH, NVRAM).

The image capture device 20, the memory unit 21 and the computation unit 22 are suitable for communicating via a communication bus.

In one embodiment, the receiver/decoder device 6 is a portable electronic device, such as a mobile phone or smartphone, an electronic tablet, a laptop computer, or any other portable electronic device equipped with a camera and an electronic computing device.

The electronic computing device 23 is configured to implement a module 24 of automatic adjustment of the sensitivity and time of exposure parameters for placing the image capture device in an image acquisition mode suitable for decoding data transmitted by visible light communication. The parameters are implemented by the image capture device 20 for digital image acquisition, at a given frequency, e.g. of 30 frames per second.

An acquired digital image is supplied to the electronic computing device by the capture device 20. The electronic computing device 23 also implements:
a module 26 for extracting a series of samples of the acquired digital image, each extracted sample taking one value among two predetermined values, in practice a series of ‘1‘ and’0’,
a module 28 for calculating and storing a plurality of sampling factors from the series of samples, each sampling factor being associated with a predetermined pattern and being indicative of a number of samples of the same value representative of the pattern and
a module 30 of application of the calculated sampling factors for demodulating and decoding at least one packet of transmitted data.

In one embodiment, the modules 24, 26, 28, 30 are embodied in the form of software instructions forming a computer program which, when implemented by a computer, implements a method of calibration of the demodulation of data modulated by amplitude modulation of a light signal as described.

The computer program including software instructions is further apt to be recorded on a non-transitory computer-readable medium. The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or an optical card.

In a variant, each of the modules 24, 26, 28, 30, is a dedicated module produced in the form of a programmable logic component, such as an FPGA (Field Programmable Gate Array), or else in the form of a dedicated integrated circuit, such as an ASIC (Application Specific Integrated Circuit).

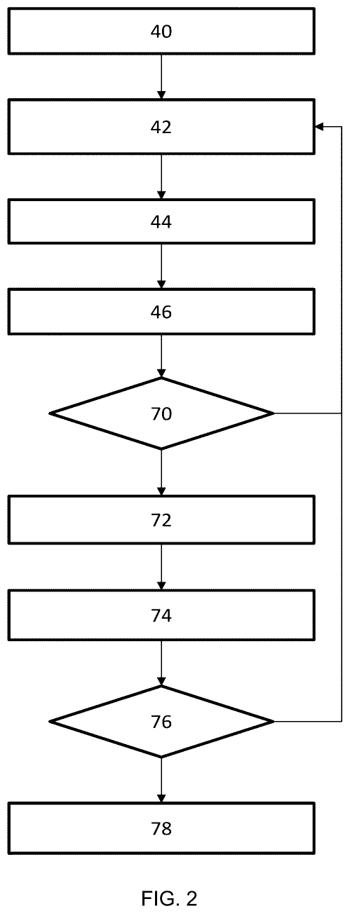

FIG. 2 is a flow chart of the main steps of an embodiment of a method of calibration of the demodulation of data modulated by amplitude modulation of a light signal emitted by a light source.

The method comprises a step 40 of automatic adjustment, also called calibration, of the sensitivity and time of exposure parameters for placing the image capture device in an image acquisition mode suitable for decoding data transmitted by visible light communication.

More particularly, the automatic self-adjustment for taking images is inhibited.

Preferably, the sensitivity is set at a percentage of the maximum sensitivity Gmax of the image capture device, e.g. 55% of Gmax.

Preferably, the time of exposure is set at about 30 microseconds. Such a time of exposure is a short time, corresponding to a high sampling rate, so as to favor the recovery of the transmitted symbols.

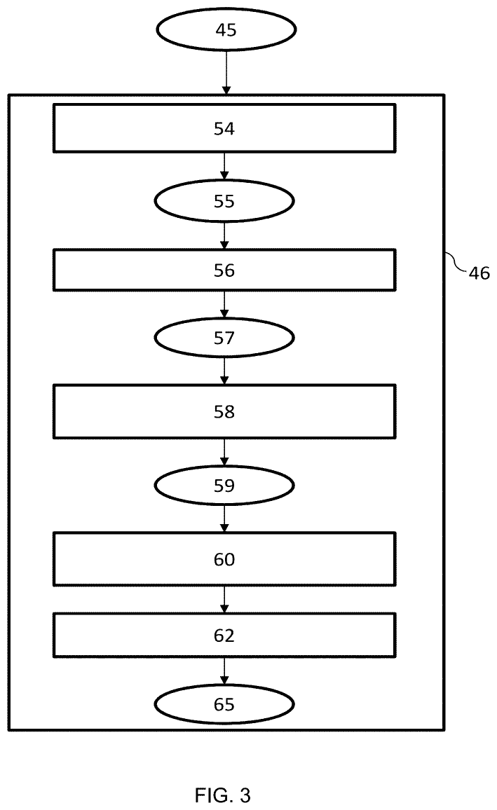

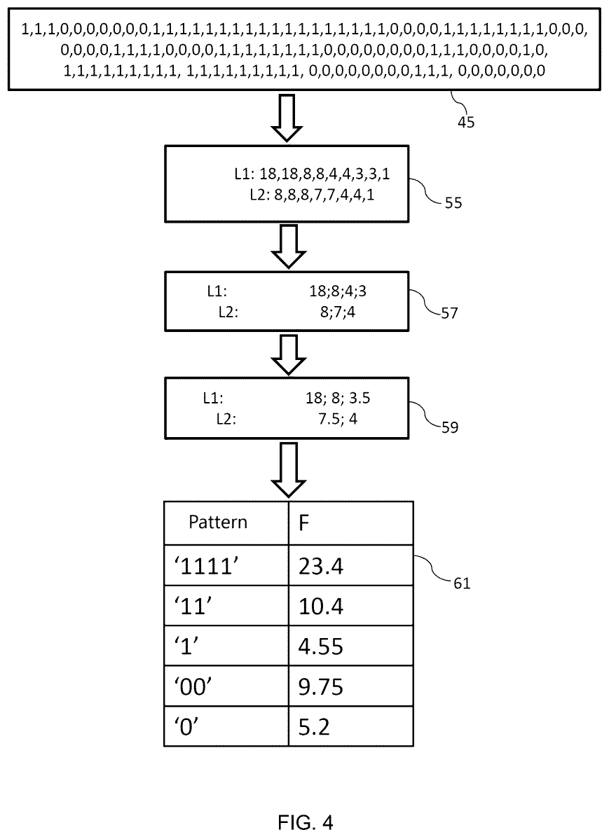

The sampling factors to be applied are computed and stored, as explained in more detail hereinafter with reference to FIGS. 3 and 4.

Step 40 is followed by a step 42 of acquisition of a digital image, obtained by the image capture device implementing the fixed sensitivity and time of exposure parameters.

Step 42 is followed by a step 44 of extraction of a series of samples of the acquired digital image, each extracted sample taking one of two predetermined values, e.g. ‘1‘ and’0’. For example, it is a series of binary data, extracted by applying a thresholding curve, from mean values per column, calculated from the luminance of the acquired digital image.

In one embodiment, step 44 implements a computation of mean values per column of the luminance of the acquired digital image, a computation of a thresholding curve from the mean values, and an application of the thresholding curve. A plurality of methods of calculation of such a thresholding curve are known in the prior art and are applicable here.

A series of samples taking values of ‘1’ or ‘0’ depending on whether the mean value of the corresponding column is above or below the corresponding value of the thresholding curve. The sample series has as many samples as the number of columns in the digital image.

In an optimized embodiment, step 44 implements:
a calculation of a mean value per column of said digital image, and a storage of the mean values per column in association with a column index, arranged between a first edge index corresponding to a first edge of said image and a second edge index corresponding to a second edge of said image;
a determination of a maximum value of said mean values, and calculation of a threshold from said maximum value,
a determination of a first column index corresponding to the first mean value greater than or equal to said threshold starting from the first edge index, and of a second column index corresponding to the first mean value greater than or equal to said threshold starting from the second edge index;
an extraction of a subset of mean values between the first column index and the second column index, and
a calculation of a thresholding curve on the subset of mean values and an application of the calculated thresholding curve to obtain a series of binary samples.

The method then comprises a step 46 of calculating a plurality of sampling factors.

Each sampling factor is associated with a predetermined pattern and is indicative of a number of samples of the same value (‘1’ or ‘0’) representative of the pattern in the series of samples.

In practice, when Manchester coding is applied, and the synchronization word ‘1111’ is used, the patterns to be taken into account are:
M₁=‘1111’
M₂=‘11’
M₃‘=1’
M₄=‘00’
M₅=‘0’

Indeed, the patterns correspond to the set of groupings of symbols of the same value likely to be validly modulated and transmitted in transmission packets by the encoder and transmitter device, when Manchester coding is applied and when the synchronization word is ‘1111’.

A sampling factor Fᵢ is associated with each pattern Mᵢ, Fᵢ being a number indicating the number of samples of the same value of the series of samples are used for modulating the pattern.

An embodiment of step 46 of calculation of a plurality of sampling factors is described with reference to FIG. 3, while FIG. 4 illustrates an example of intermediate results obtained during the implementation of the calculation.

Thereby, starting from a series 45 of samples taking binary values (or symbols), ‘1’ or ‘0’, respectively, an example of which is given in FIG. 4, the method comprises a step 54 of counting the numbers of successive samples of each value, i.e. ‘1’ or ‘0’, and of storage of the numbers of samples, sorted in descending order, in a list associated with the value. The result of step 54 is referenced 55.

As shown in the example of FIG. 4, at the end of step 54: a list L1 of numbers of successive ‘1’ in the series 45, and a list L2 of numbers of successive ‘0’ in the series 45, are obtained respectively.

The method then comprises a filtering step 56, during which only the distinct numbers having an occurrence greater than or equal to 2 are retained in each list. The result of step 56, referenced 57, is illustrated in the example shown in FIG. 4.

Thereby e.g., in the list L1, the numbers 18, 8, 4 and 3 are retained, and the number “1” corresponding to a single occurrence is removed.

Advantageously, as a result, possible isolated errors are eliminated.

The method includes a grouping step 58 including a replacement, in the corresponding list, of the counted numbers distant by at most a predetermined distance threshold, by an updated number equal to the mean value of said counted numbers distant by at most the predetermined distance threshold.

For example, the predetermined distance threshold is equal to 2.

The result of step 58, referenced 59, is illustrated in the example shown in FIG. 4. In the example, in list L1, the numbers 4 and 3 are replaced by 3.5 and in list L2, the numbers 8 and 7 are replaced by 7.5.

The numbers retained at the end of step 58 are called updated numbers.

As can be seen from the example, the updated numbers are real numbers, whereas numbers initially counted are integers.

The updated numbers are representative of merged adjacent values.

Of course, variants in the implementation of the steps described hereinabove within the scope of a person skilled in the art can be envisaged.

Other calculation variants can be envisaged, e.g. the calculation of an updated number by calculating the mean value of the numbers distant by at most the predetermined distance threshold.

The method then comprises a step 60 of detection of the presence of the predetermined synchronization word in the series.

In one embodiment, the synchronization word is ‘1111’, which corresponds to the pattern M₁.

In one embodiment, step 60 implements the calculation of the ratio of the first two numbers of list L1 (list relating to the numbers of successive ‘1’ counted).

When the calculated ratio lies within a given range of values, e.g. between 1.7 and 2.3, it is considered that the detection is positive.

In the event of a positive detection in step 60, the method comprises a calculation 62 of the sampling factors by multiplying each updated number by a predetermined uncertainty coefficient.

For example, the predetermined uncertainty coefficient is K=1.3, which corresponds to a margin of uncertainty of 30%. Other uncertainty coefficient values are possible, e.g. between 1.1 and 1.4 corresponding to a margin of uncertainty varying between 10% and 40%.

Thereby, Table 61, illustrated as an example in FIG. 4, is obtained, which contains the calculated sampling factor F associated with each pattern considered.

Of course, other storage structures can be used to store the sampling factors associated with each pattern considered.

In one embodiment, the effective sampling factors, applied for the demodulation, are integer factors obtained from the calculated sampling factors. For example, each integer factor is chosen as the integer closest to the calculated sampling factor. The respective steps of acquisition 42 of a digital image, of extraction 44 of a series of samples of the acquired digital image and of calculation 46 of a plurality of sampling factors from the series of samples are implemented for a plurality of P images, P being a predetermined number greater than or equal to one, preferably greater than or equal to two, e.g. equal to 25. The sampling factors, for each pattern and for each processed digital image, are stored.

The method includes, when the number P is greater than or equal to two, after the predetermined number P of images has been reached (verification 70), a step 72 of calculation of a mean sampling factor per pattern equal to the mean value of the sampling factors associated with said pattern calculated for each acquired digital image.

The method then includes a step 74 of application of the sampling factors for the recovery of at least one data packet.

Preferably, the sampling factors are applied for recovering data packets from a plurality of P′ acquired digital images, P′ being a predetermined number, greater than or equal to 2, e.g. 10.

A validation of the recovered data is then performed by applying an error detection code and a percentage of validated demodulations is calculated.

More generally, a validity indicator is calculated from all the P′ processed images.

The validity indicator is compared with a predetermined validity threshold, e.g. equal to 80% when the indicator is the percentage of validated demodulations.

More generally, the validity threshold is e.g. between 60% and 100% when the indicator is the percentage of validated demodulations.

If the validity threshold is reached or exceeded (test of step 76), the mean sampling factors are stored during the storage step 78 for the image capture device used.

Subsequently, the stored sample factors are used for the demodulation and the decoding of transmitted data.

If the validity threshold is not reached, steps 42 to 76 are iterated on subsequent digital images, to which e.g. a denoising or correction filter is applied.

Advantageously, in one embodiment, the sampling factors are calculated on a plurality of acquired digital images, which leads to good statistical representativeness of the operation of the image capture device.

Advantageously, the method automatically provides a fine adaptation to any specific non-linearity of the image capture device used. Thereof makes possible an application with any image capture device already installed in a model of electronic devices already marketed.

1. A method for calibrating the demodulation of data modulated by amplitude modulation of a light signal emitted by a light source of an encoder the modulated data being encapsulated in formatted transmission packets, the method being implemented by a demodulation calibration device including a digital image capture device having associated sensitivity and time of exposure parameters, and an electronic computing device configured to receive digital images acquired by said image capture device, the method comprising the steps of:
A) automatic adjustment of the sensitivity and time of exposure parameters for placing the image capture device in an image acquisition mode suitable for decoding data transmitted by visible light communication,
B) acquisition of a digital image by that digital image capture device, a digital image acquired comprising a zone comprising a zone with light and dark fringes, corresponding respectively to high and low states of the received light signal,
C) extraction of a series of samples from the acquired digital image, each extracted sample taking one of two predetermined values,
D) calculation of a plurality of sampling factors from said series of samples, each sampling factor being associated with a predetermined pattern and indicative of a number of samples of the same value representative of said pattern, and storage, for each predetermined pattern, of the calculated sampling factor associated to said pattern.

2. The method according to claim 1, further including a step of application of the calculated sampling factors to recover at least one transmitted data packet.

3. The method according to claim 2, including after recovery of at least one packet of transmitted data, validation of said data by application of an error detection code.

4. The method according to claim 1 including the application of steps B) to D) to a predetermined number P of acquired digital images, in order to obtain a plurality of sampling factors per acquired digital image, and a calculation of a mean sampling factor per pattern, equal to the mean value of the sampling factors associated with said pattern for each acquired digital image.

5. The method according to claim 4, further including an application of the mean sampling factors for a recovery of transmitted data, for a plurality of digital images, of at least one packet of transmitted data per digital image, a validation of the recovered data by application of an error detection code, and a calculation of a validity indicator.

6. The method according to claim 5, wherein if the validity indicator is less than a validity threshold, steps B) to D) are iterated over said predetermined number of subsequent acquired digital images.

7. The method according to claim 1, wherein the step D) of calculation of a plurality of sampling factors from said series of samples includes:
for each sample value, a count of the numbers of successive samples taking said value, and an arrangement of the numbers counted in descending order in a list associated with said sample value.

8. The method according to claim 7, including, for each list, a filtering for retaining only distinct numbers having an occurrence greater than or equal to two.

9. The method according to claim 8, including grouping of the counted numbers distant by at most the predetermined distance threshold, the grouping including a replacement, in the corresponding list, of said counted numbers distant by at most the predetermined distance threshold by an updated number equal to the mean value of said counted numbers distant by at most the predetermined distance threshold.

10. The method according to claim 9, further including a detection of the presence in one of said lists of an updated number corresponding to a predetermined synchronization word.

11. The method according to claim 10, including, in the event of positive detection, a calculation of said sampling factors by multiplying each updated number by a predetermined uncertainty coefficient.

12. The method according to claim 1, wherein the sensitivity is adjusted to 55% of a maximum sensitivity of the image capture device.

13. A device for calibration of demodulation of data modulated by amplitude modulation of a light signal emitted by a light source of an encoder device, the modulated data being encapsulated in formatted transmission packets, including a digital image capture device having associated sensitivity and time of exposure parameters, and an electronic computing device configured to receive digital images acquired by said image capture device, configured to implement a method according to claim 1.

14. The demodulation calibration device according to claim 13, said device being a mobile phone or an electronic tablet.
